(19) United States
(12) Patent Application Publication
(10) Pub. No.: US 2025/0034017 A1
(43) Pub. Date: Jan. 30, 2025

(54) PREVENTION OF SCALE FORMATION AND CORROSION UTILIZING BLENDED MEDIA IN CONTAINED FLUIDIZED BEDS

(71) Applicant: One Green Commercial LLC, Henderson, NV (US)

(72) Inventors: Gary HATCH, Henderson, NV (US); Gregory LUCAS, Henderson, NV (US)

(21) Appl. No.: 18/778,338

(22) Filed: Jul. 19, 2024

Related U.S. Application Data
(60) Provisional application No. 63/527,786, filed on Jul. 19, 2023.
(60) Provisional application No. 63/569,025, filed on Mar. 22, 2024.

(51) Int. Cl. C02F 5/08; C02F 101/10

(52) U.S. Cl. CPC C02F 5/083; C02F 2101/10; C02F 2201/002; C02F 2303/08

(57) ABSTRACT

A system and method for controlling scale formation and corrosion in a water system flows water through a contained fluidized bed (CFB) configured to retain components of a blended media including: (a) calcium carbonate granules; (b) activated glass granules; (c) pumice; and (d) one or a combination of silicates selected from alkaline earth metal silicates (AEM) and alkaline metal (AM) silicates. The silicates are configured for variable solubility by releasing a first level of silica for passivation and at least one second level of silica lower than the first level for maintenance of passivation.

### RELATED APPLICATIONS

This application claims the benefit of the priority of U.S. Provisional Applications No. 63/527,786, filed Jul. 19, 2023, and No. 63/569,025, filed Mar. 22, 2024, each of which is incorporated herein by reference in its entirety.

### FIELD OF THE INVENTION

The present invention relates to a system and method for reducing scale build-up and corrosion of equipment.

### BACKGROUND

Food services, beverage dispensing, hospitality, food production, and related business utilize many different types of equipment in the preparation of food and beverage products. Such equipment includes, for example, steamers for warming and heating prepared food, hot water heaters for home and commercial use, coffee makers, ice machines, and equipment for dispensing beverages and water. Incoming water purity is essential for optimum operation and maintenance of this equipment. Among the problems frequently encountered in the maintenance of such equipment is hard scale formation. Similar challenges are encountered in industrial operations and by businesses that support and maintain residential, commercial, and industrial equipment, such as home appliances, boilers, heating systems, and more, which can be damaged and prematurely fail due to poor water quality.

Many of these businesses rely on water pretreatment for protecting their equipment and their customers from certain impurities in the incoming water such as suspended solids, off taste or odors, and other aesthetic and health related contaminants. However, one of the most troublesome water parameters that causes severe operational and maintenance problems for this equipment is water hardness. Water hardness is simply defined as the presence of calcium ions (Ca⁺²) and magnesium ions (Mg⁺²). Therefore, under the right conditions of heat, surface area and/or concentration, when these ions exist in water in combination with alkalinity (bicarbonate ions, HCO₃⁻¹ and carbonate ions, CO₃⁻²), and at higher pH, these ions begin to form “scale”. Scale, typically as calcium carbonate, CaCO₃ and magnesium carbonate, MgCO₃, can form either as flake-like suspended particles or can attach to surfaces such as in heat exchangers, heating elements in water heaters, boilers, or on internal surfaces of the above-mentioned food service equipment. With untreated water having high hardness, scale formation can cause inefficient operation and costly maintenance issues for food service and beverage dispensing commercial businesses. Therefore, it is vital for these businesses to have optimal water treatment for scale prevention.

Many different methods have been applied over the past decades to inhibit scale formation on equipment. More recently, approaches have included use of flow-through fluidized beds of calcium-form weak acid cation (WAC) ion exchange resins (Leiter and Walder, U.S. Pat. No. 6,593,379; Walder and Leiter, U.S. Pat. No. 6,660,167; and Koslow, U.S. Pat. No. 9,879,120), the disclosures of which are incorporated herein by reference. The '379 patent describes a method for converting the WAC resin from the acid form (H⁺¹) directly to the calcium form (Ca⁺²) using calcium hydroxide (Ca(OH)²):

2Res-COO⁻¹(H⁺¹)+Ca(OH)₂→(Res-COO⁻¹)₂—Ca⁺²+2H₂O

A more indirect method of making the same resultant calcium-form WAC resin is disclosed by Koslow in the '120 patent.

The method of “descaling” a water with high hardness is described in the '167 patent by Walder and Leiter as “catalytic calcium carbonate (CaCO₃) crystal seed formation”. However, Koslow ('120) offers a different explanation for the seed formation—that of inter-changing of calcium ions (Ca⁺²) in the hard water with the calcium ions bonded to the resin. This occurs at the electric double layer adjacent to the resin surface where the concentration of calcium ions become super-saturated. When the calcium ions become super-saturated in the presence of alkalinity, microcrystalline calcium carbonate seed crystals are formed. In both scenarios, under dynamic flow operation, once the seed crystals are formed near the surface of the fluidized resin beads, they are flushed downstream and do not adhere to equipment surfaces to form troublesome scale deposits.

Unfortunately, these Ca-resins have less than optimal efficiency in preventing scale formation, especially under conditions of varying water flow rates. Ca-resins typically require a fairly high flow velocity to fluidize the resin beads to flush away the microcrystalline scale particles. Even so, at best, depending on how they are made, they operate only at 50-75% efficiency for scale prevention (see Koslow, '120).

These resin-based media have certain other disadvantages and limitations, such as being susceptible to higher concentrations of chlorine and chloramine, easily fouled by organics or iron, copper, manganese, or other metals, are operational up to only pH 8.5, and require high “freeboard” (200% of depth) which limits application space.

In addition, their effectiveness for scale control may be severely limited by silica that is naturally present in many well waters because of the potential for calcium ion (Ca⁺²) to form insoluble calcium silicate (CaSiO₃) on the surface of the Ca-resin. This phenomenon was observed by researchers in a recent Virginia Tech study (“A Standardized Test Protocol for Evaluation of Scale Reduction Technologies”, Environmental Engineering Science, C. Devine, et al., Vol. 38, No. 12, 2021). This study tested a device which was referred to as a “media-induced precipitation” device and is believed to contain a Ca-form resin. The device became ineffective for controlling scale after only 5 days of use in presence of 20 mg/L silica in the test water.

These resin-based media are also very costly and difficult to produce requiring specialized equipment, handling and chemical discharges. Another disadvantage of Ca-resins is that the mechanism described above releases carbonic acid (H₂CO₃) which may lead to corrosion of downstream equipment over time.

In an alternative approach, sodium silicates have been used for decades to control scale formation in hard water. Municipalities employ silicates for preventing scale formation in their distribution systems and in private and public water lines. This application of silicates is usually done using a concentrated liquid form of sodium silicate which is injected in-line as the treated water flows from the treatment plant into the distribution system. Other larger scale applications (e.g., cooling towers, boilers, etc.) use this same in-line injection technique. These types of large in-line injection systems offer excellent efficiency and scale prevention because they can be highly controlled and monitored.

Some smaller systems, such as point-of-use (POU) and point-of-entry (POE) systems, utilize solid, soluble sodium silicates in flow-through beds. In these applications, it is difficult to control release of high concentrations of silica, especially at start-up following long periods of non-flow. Other devices use large spheres, lumps or granules of sodium silicates in a “bleeder” canister where incoming water flows over or around a small opening in the canister, allowing silica to bleed therefrom. The slightly soluble silica (as SiO₂⁻¹ or SiO₃⁻²) sequesters with the Ca⁺² ion in the incoming water and is carried downstream without forming hard scale. However, this method of use is less efficient, with little control over the release of silica at varying flow rates which impacts the anticipated life of the silicate material. In addition, during long periods of shut-down or non-flow, the silicate bed in the “bleeder” cartridge may transform into a solid “cake”, preventing release of effective levels of silica for controlling scale formation.

Certain other metal silicates have also been used for scale control. See, for example, U.S. Pat. No. 8,623,273 (Lu) and U.S. Pat. No. 6,365,101 (Nguyen, et al.), each incorporated herein by reference. These disclosed approaches pertain primarily to “in solution” industrial applications. In the Lu patent ('273), the primary action involves co-precipitation of the “scale-forming material” (Ca⁺² as CaCO₃) in the “scale-forming fluid”, followed by adsorbing the “scaling compound” (CaCO₃) by the “anti-scale material”. The primary “anti-scale material” claimed in this patent is calcium silicate. The processing is carried out in a bulk liquid solution by adding very fine “anti-scale materials” to the bulk liquid manually (as a separate physical action, e.g., injection) as very small particles, e.g., 2-18 μm.

The Nguyen ('101) patent also describes treatment of “scale-forming” bulk liquid by manual addition, e.g., injection, of anti-scalants, primarily polyvalent metal silicates/alumino-silicates and polyvalent metal carbonates. Nguyen suggests three possible mechanisms for scale prevention: 1) ion exchange of sodium ions (Na⁺¹) for calcium ions (Ca⁺²); 2) nucleation initiator/promoter which promotes formation of microcrystalline CaCO₃ particles (similar to what Ca-Resin does); and 3) adsorption of the formed small micro-crystals onto the anti-scale particles. Ion exchange is discounted as a primary anti-scale function due to the very low ion exchange capacity of the anti-scale materials. These inventors suggest that surface adsorption of the microcrystalline scale particles onto the anti-scalants may be a significant contributor to the anti-scale function, but it performs independently from ion exchange. The '101 patent describes synergistic action between silicates and Ca⁺², in solution, however the solution would need to be filtered out before delivering the treated water. The example approaches by both Nguyen and Lu require eventual “blow down” or flushing out, or filtering out, the suspended scale solids or precipitated scale sludge from the heat exchangers or boilers. Accordingly, such methods and materials are not applicable to flow-through POU and POE potable water treatment.

Specific silicate formulations are needed to enhance the stability of metal silicates (specifically sodium silicates) and provide greater control over the release of silica to: 1) provide initial “passivation” (coating) of the downstream equipment that is susceptible to scale formation; 2) after the passivation period, help prevent uncontrolled release of high slugs of silica at start-up after long stagnation periods, and allow continuous release of low “maintenance levels” of silica for longer term use; 3) help prevent release of slugs of high pH water from the more soluble silicates; 4) help prevent the bed of sodium silicate beads or granules from solidifying into a solid cake during longer terms of non-use or stagnation; and 5) overall, allow for better, controlled release of silica during continuous periods of intermittent (on-off) flow, or during longer periods of continuous flow, or during higher or lower flow rates. The system and methods disclosed herein are directed to such improvements.

### SUMMARY

The improvements disclosed herein are directed toward point-of-use (POU) or point-of-entry (POE) water treatment by combining specially formulated solid metal silicates having controlled release of silica with a blended mix of anti-scale/corrosion media that meet all state and federal drinking water aesthetic and health standards, while still providing for scale prevention and corrosion control at varying flow rates in a properly designed POU or POE water delivery system.

According to some embodiments of the inventive system and method, a fluidized bed contacter (FBC) comprises specially processed metal silicates along with specially formulated “mixed-form” (Na⁺¹/K⁺¹/Mg⁺²/Ca⁺²/Ba⁺² metal silicates, and a blend of specially formulated anti-scale/corrosion ingredients to provide effective scale and corrosion prevention without adding undesirable compounds to the water.

In one aspect of the invention, a system for controlling scale formation and corrosion in a water system includes: a contained fluidized bed (CFB) configured to retain components of a blended media, the components including: (a) calcium carbonate granules; (b) activated glass granules; (c) pumice; and (d) one or a combination of silicates selected from alkaline earth metal silicates (AEM) and alkaline metal (AM) silicates, wherein the one or a combination of silicates is configured for variable solubility by releasing a first level of silica for passivation and at least one second level of silica lower than the first level for maintenance of passivation, wherein the CFB is configured for receiving an input water flow and outputting an output water flow. In some embodiments, the AEM is one or more of magnesium, calcium and barium, and the AM is sodium and potassium. Component (b) may be configured for creating suspended micron- and sub-micron CaCO₃ crystals for seeding Ca⁺² ions from hard water and forming microcrystalline CaCO₃ that remains in solution. Component (a) may be configured for creating suspended micron- and sub-micron CaCO₃ crystals for seeding Ca⁺² ions from hard water and forming microcrystalline CaCO₃ that remains in solution. In some embodiments, the CFB may be multiple beds in fluid communication, where each bed is configured to retain from one to three of components (a)-(d). In some embodiments, the CFB includes multiple beds in fluid communication, where at least a first bed of the multiple beds retains component (a). In some embodiments, the CFB comprises multiple beds, each bed comprising a vertically-oriented column disposed within an array of parallel columns. In other embodiments, the CFB may be multiple beds, each bed comprising a vertically-oriented column disposed within a series of columns. Component (c) may be aluminosilicates. The components may further include sodium hexameta phosphate (SHMP).

In another aspect, a method for controlling scale formation and corrosion in a water system, comprising pumping water into any embodiment of the above-described system.

### BRIEF DESCRIPTION OF THE DRAWINGS

FIG. 1 is a diagrammatic view of a fluidized (up-flow) bed assembly according to an embodiment of the inventive system.

FIG. 2 is a diagram of a standard test rig used to evaluate the inventive approach.

FIG. 3 is a photograph of four heating rods used in a first evaluation (Test Run #1) of the inventive approach.

FIG. 4 is a photograph of two heating rods used in a second evaluation of the inventive approach.

FIG. 5 is a photograph of two heating rods used in a second evaluation of the inventive approach.

### DETAILED DESCRIPTION OF EMBODIMENTS

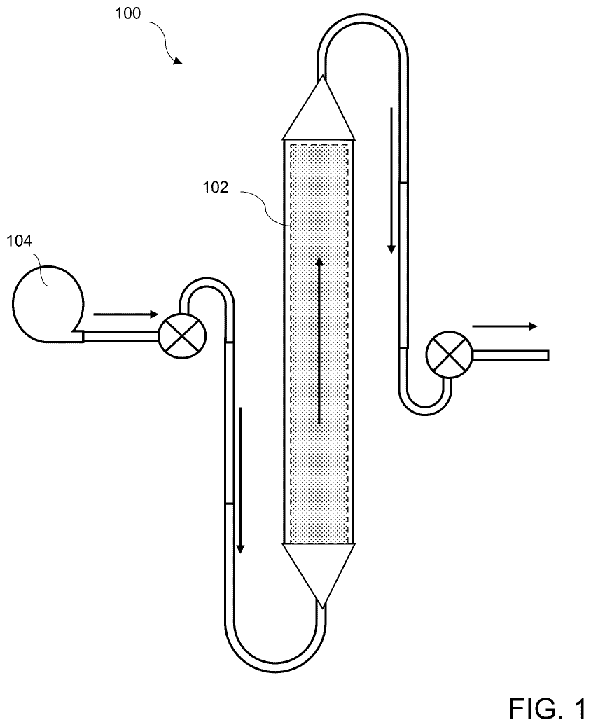

Referring to FIG. 1, the inventive system (fluidized media during optimum flow) 100 for scale and corrosion prevention comprises a fluidized bed contacter (FBC) containing one or more mixed bed including blended media in varying amounts of each of (1) fine mesh granular calcium carbonates; (2) fine mesh activated glass (Dryden Glass, Dryden Aqua LLC); (3) varied mesh sodium or potassium silicate and/or calcium and/or magnesium silicates; and/or (4) a pumice material consisting of primarily aluminosilicates.

One or more additional (optional) components of the blend may include sodium hexameta phosphate (SHMP).

As will be recognized by those of skill in the art, the diagram is highly simplified and does not show various valves, gauges, filters, and other components that would commonly be included in a water treatment system. The bed is illustrated as a vertically-oriented column 102 with flow from bottom to top of the column providing for fluidization of the blended anti-scale/corrosion media. The bed system 100 may be plumbed to include replaceable in-line columns or cartridges that can be easily switched out when fresh bed materials are needed, or each column may be an assembly of a fixed chamber with a removable/replaceable cartridge containing the bed materials. The inventive system is not limited to a single column, or any specific number of columns, but instead allows materials to be combined in a variety of ways to best suit the intended application. For example, a single bed may include a blend of all four media types listed above; each bed of tandem beds may contain two media types, or two of more beds may include mixtures of all or some of the four media types. Many different permutations may be employed. The examples below describe a variety of different fluidized bed permutations that produce the desired anti-scale/anti-corrosion results.

Calcium carbonate granules-Calcium carbonate granules may be provided in the form of 30×50 mesh (0.3-0.6 mm) granules (Huber Carbonates, Atlanta, GA). This material is believed to control scale by forming “micron and sub-micron” sized calcium carbonate particles generated by the coarser granules abrading each other during fluidization of the bed. These very small calcium carbonate particles then act as a “nucleation initiator/promoter” for forming the suspended microcrystalline particles as described by Nguyen, et al. in US patent '101, column 10, lines 33-65. Also, the calcium carbonate granules may be operating in another scale control mechanism as proposed by Koslow.

Activated glass particles—This unique material (0.7-2.0 mm) is made from reprocessed insoluble glass (silica, SiO₂). The “activation” process described in UK Patent Application GB2521667 of Dryden Aqua, incorporated herein by reference, creates negative charges on the surfaces of the glass media that attract calcium ions (Ca⁺²) in the hard water. It is believed that the surface of the glass media when coated with calcium ions creates an electric double layer, then acts similarly as does the Ca-resin as described by Koslow. During up flow, the fluidized glass particles can also abrade the calcium carbonate particles to generate the micron and sub-micron “seed” particles for creating the microcrystalline scale.

Metal Silicates for Scale and Corrosion Control-Many types of metal silicates are known in the art for scale prevention, however, the example implementations disclosed herein employ metal silicates in what is believed to be a novel approach in combination with the other blended materials. The starting material for fabrication of the metal silicates may be sodium silicate in a powder, granular or bead form having a silicate-to-alkali metal (sodium or potassium) weight ratio from about 3.22 to about 2.00.

Sodium silicate “glass” is a slightly water-soluble product made by fusing soda (Na₂O) and silica (high purity sand, SiO₂) at very high temperatures. A dry sodium silicate with a high silica to soda ratio (SiO₂:Na₂O) creates a very slightly soluble media that releases low levels of ‘silicates’ in water for preventing scale and corrosion in hard water (see PQ Corporation Bulletins 17-2B and 37-3). The release of silicates for effective control of scale can be largely controlled by utilizing the appropriately sized particles of the dry sodium silicate glass media. A blend of smaller sized particles (e.g., 0.4-2 mm, more soluble) of sodium silicate with larger particles (lumps, 1-3 cm, less soluble) will provide for the initial “passivation dosage” for the downstream equipment along with a longer term lasting “maintenance dosage” from the larger size particles.

A supplier of appropriate metal silicates is The PQ Corporation (Valley Forge, PA), although other sources will be known to those in the art. The metal silicates can be anhydrous (0% water) or made with varying amounts of hydration, e.g., 0% to 18%, based on the processing conditions (temperature and pressure). The anhydrous metal silicate may be processed in different ways to create multiple treatment features, e.g., for controlled release of silica. Sodium silicate may be treated with calcium chloride (CaCl₂)) or magnesium chloride (MgCl₂) using varied concentrations and optimizing reaction times to coat or partially convert the sodium silicate to the lesser soluble calcium or magnesium silicate, thereby controlling the release of soluble silica. Ideally, the sodium silicate or converted metal silicate would be slightly water soluble for initial release of moderately higher concentrations of silica (up to about 20-30 mg/L as SiO₂) for initial “passivation” (coating, as mentioned above) of the internal surfaces of the downstream equipment that is to be protected from hard scale formation or corrosion.

After this initial passivation, only low “maintenance” levels of silica are needed to retain the initial silicate coating. For maintaining passivation, a specially processed sodium silicate (see use of larger aggregates below) or formulated mixed-form silicate can provide a lower release of silica. The mixed-form silicate material may comprise sodium silicate partially converted, from about 10% up to about 90%, to calcium silicate with the general formula, CaSiO₃. The higher percentage calcium silicate material is very slightly soluble in water and would provide for a longer term, low level release of silica after passivation (at about 4-12 mg as SiO₂/L).

An alternative approach for providing initially higher passivation levels of silica followed by reduced maintenance level release of silica after passivation is to employ an optimum blend of smaller sized (more soluble) sodium silicate (e.g., 4×12 mesh, 1.65 mm×4.7 mm), with larger sized (½ inch up to 1½ inch avg. size) aggregate sodium silicate. This larger aggregate particle size has much lower surface area which would allow for very slow dissolution and lower release of soluble silica to provide maintenance levels.

The following chemical reactions depict the sequence of treatment by the inventive system and method.

Blended Anti-Scale/Corrosion Media—While not wishing to be bound by theory, it is hypothesized that the inventive blend utilizes multiple synergistic mechanisms for treating water hardness and controlling corrosion by: 1) physically forming suspended calcium carbonate microcrystalline scale particles from abrasion of the fluidized calcium carbonate granules with the activated glass granules creating a nucleation “seeding” process (see, e.g., Nguyen et al., '101); 2) chemically forming suspended calcium carbonate microcrystalline scale particles by ion-exchange in the electric double layer of the activated glass media (see Koslow '120 and J. Electroanal. Chem., 22 (1969), p. 1-7; Tadros and Lyklema, “The Electrical Double Layer on Silica in the Presence of Bivalent Counter-Ions”); 3) chemically sequestering calcium hardness ions, Ca⁺², by the controlled release of soluble silicate, thereby also forming suspended calcium silicate particles (CaSiO₃) (see Chemical Engineering Research and Design, 110 (2016), p. 98-107, Al Nasser, et al., “Effect of silica nanoparticles to prevent calcium carbonate scaling using an in situ turbidimeter”, and 4) The soluble silicate, SiO₃₋₂ chemically reacting with the downstream metal surfaces to form a metal-silicate coating for preventing corrosion. (See PQ Corporation Bulletin 37-3, PQ® Soluble Silicates: For Protection of Water Systems From Corrosion, available on the World Wide Web at muirsbeachcsd.com/documents/SolubleSilicates.pdf, incorporated herein by reference, which describes how to best utilize sodium silicates for optimum scale and corrosion control.)

SHMP: Optional blended media component Sodium Hexameta phosphate (SHMP) has been utilized as an anti-scale and corrosion inhibitor for many decades. Its mechanism of scale and corrosion control is very similar to silicates—that is, coating or passivation of the downstream equipment with an insoluble calcium phosphate film. SHMP is somewhat soluble in water but could be controlled by using only a small amount of larger sized particles (flakes, 1-3 cm; Global Chemical Resources, Chicago, IL) only for the initial passivation phase of treatment.

The mechanisms can be described by the following physical interactions and chemical reactions:

### Mechanism 1. Nucleation “Seeding” Mechanism—

$${CaCO}_{3 ( H 2 O )} granules + {Activated Glass granules}_{( H 2 O )} + fluidization ↑ ( up flow ) \to * {CaCO}_{3 ( H 2 O )} ( suspended microcrystals )$$

### Mechanism 2. Ion-Exchange in the Electric Double Layer of the Activated Glass Media (2-Step Process)—

Hard water:

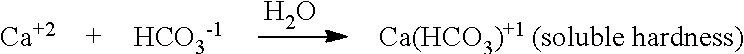 [SMILES: O ; [Ca+2] ; "HCO3-1" ; "+" ; "Ca(HCO3)+1 (soluble hardness)"]

Step 1: Activated Glass (AG) granules in hard water—

AG^{-x} (x=very high negative surface charges)+Ca(HCO₃)⁺¹→(AG^{-x})(Ca(HCO₃)⁺¹) (highly concentrated soluble hardness in AG^{-x} double layer).
Step 2:

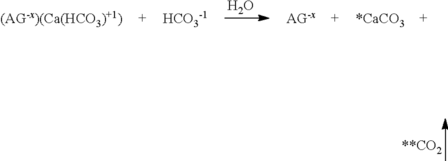

where HCO₃⁻¹ is bicarbonate, *CaCO₃ is suspended microcrystalline scale particles, flushed downstream (no scale formed), and **CO₂, is carbon dioxide gas.
Mechanism 3. Chemically Sequestering Calcium Hardness Ions, Ca⁺², by the Controlled Release of Soluble Silicate to Form Suspended Calcium Silicate Particles, CaSiO₃—
Sequestering with soluble sodium or potassium silicates (alkaline metal silicates):

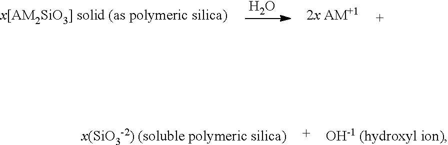

where AM, alkaline metal is either sodium (Na⁺¹) or potassium (K⁺¹), followed by hydrolyzed polymeric silica to the SiO₃⁻² monomer,

x(SiO₃⁻²)+H₂O [symbol] xSiO₃⁻² (hydrated monomer), followed by,

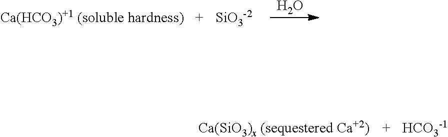

Sequestering with slightly soluble alkaline earth metal (AEM) silicates:

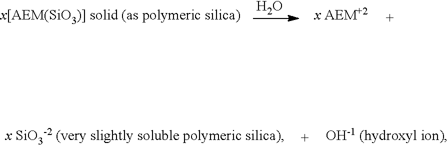

where AEM (alkaline earth metal)=calcium (Ca⁺²), magnesium (Mg⁺²) or barium (Ba⁺²), followed by the hydrolyzed silica monomer (SiO₃⁻²) sequestering with the soluble hardness (Ca(HCO₃)⁺¹) as shown above.
Mechanism 4. The Soluble Silicate, SiO₃₋₂ Chemically Reacts with the Downstream Metal Surfaces—

The following reaction describes the silica interaction with metal and metal oxide surfaces for controlling corrosion (from PQ Corporation Bulletin 37-3, supra):

[(-M(OH))—O-(M(OH))]+Si(OH)₄ [symbol] [(-M-O-M)-O₂Si(OH)²],

where, [(-M(OH))—O-(M(OH))] represents an anodic metal surface area showing an oxidized metal oxide (M-O) or metal hydroxide (M-OH) at the initial stage of corrosion. The polymeric Si(OH)₄ depolymerizes to SiO₃⁻² (as depicted in the above reactions) and reacts with the metal hydroxides to form a thin monomeric metal silicate film on the metal surface preventing any further corrosion.

The following non-limiting examples describe exemplary implementations of the inventive system and methods for anti-scale/corrosion application. As will be apparent to those of skill in the art, these examples are intended to be illustrative only. Further variations of the blends in terms of ratios, quantities, and other parameters, and/or addition of other materials may be used to achieve the same or similar results.

### Example 1: Blended Media

The anti-scale/corrosion blended media beds according to embodiments of the inventive fluidized bed contacter (FBC) employ varying combinations and amounts of the following materials, including:
Calcium Carbonate Granules
Activated glass (AG) granules
Aluminosilicate (in the form of pumice)
Sodium silicate (mix of varying sizes)
Calcium silicate
Magnesium silicate
Barium silicate
Heterogeneous or homogenous mixed forms of sodium silicate, potassium silicate, calcium silicate, magnesium silicate, or barium silicate

Calcium silicate (CaSiO₃), magnesium silicate (MgSiO₃), and barium silicate (BaSiO₃) are much less soluble than sodium silicate and therefore can be formulated to balance release of the proper amount of silica when combined with an appropriate amount and/or size (granules or aggregates) of the more soluble sodium silicate. Optimal mixtures of these metal silicates may be formulated depending on the desired operational flow rate, water hardness and temperature. As mentioned above, sodium silicate may be reacted with the corresponding alkaline earth metal chloride salt (MgCl₂, CaCl₂) or BaCl₂) in proportions described below to provide the desired level of silica release.

In some aspects of the inventive system, a fluidized bed system for controlling scale formation and corrosion includes a treatment bed comprising one or more silicate bed utilizing very slightly soluble alkaline earth metal silicates (AEM) and/or slight to moderately soluble alkaline metal (AM) silicates, or a combination of differently sized alkaline metal silicates. In some embodiments, the one or more silicate bed may comprise beds of homogeneous mixed-form AEM silicates and/or mixed-form AM silicates each having from about 5% AEM (or AM) up to about 95% AEM (or AM), any remainder being another AEM (or another AM) silicate. The AEM may be 100% form of either calcium ion (Ca⁺²), magnesium ion (Mg⁺²) or barium ion (Ba⁺²). Alternatively, the silicate may be a homogeneous mixed-form AEM silicate, either of two forms may be calcium and magnesium, or calcium and barium or magnesium and barium silicate, having from about 5% AEM up to about 95% AEM, with the remainder being another AEM form.

In still another aspect of the inventive system, a multi-media bed system for controlling scale and corrosion formation includes one or more bed of the following, in varying proportions: calcium carbonate (CaCO₃) granules, a pumice material comprised of aluminosilicate, activated glass (AG) granules, and one or more metal silicate comprising very slightly soluble alkaline earth (AEM) metal silicates and/or slight to moderately soluble alkaline metal (AM) silicates as described above.

The AM silicate may be a sodium ion (Na⁺¹) silicate, a potassium ion (K⁺¹) silicate, or a homogeneous mixture thereof. In some embodiments, the mixture may comprise the sodium silicate form having from about 5% up to about 95% with the remainder being the potassium form silicate.

In some embodiments, the one or more silicate may be AEM silicate formulations including a homogeneous mixed-form of AEM silicate and AM silicate, where the AM silicate has from about 5% up to about 100% sodium form, any remainder being an AEM form.

In some embodiments, the AEM is one or more of calcium, magnesium, and barium. In other embodiments, the AM is potassium. In still other embodiments, the AEM and AM are a mixture of potassium, sodium, magnesium, calcium and barium.

The following provides examples of different approaches that may be used to combine the blended media to achieve the desired anti-scale/anti-corrosion results. For simplicity, the components of the blended media are grouped into four different media types (#1-#4) according to their principal materials using the indicated code:
#1—Calcium Carbonate (“CC”), CaCO₃, 30×50 mesh
#2—Activated Glass (“AG”), Dryden Glass, Grade 1, hydrophilic, 0.4-0.8 mm
#3—Sodium Silicate (“SS”), processed from SS-22 Lumps of silicate glass, 20 mesh to 1½ inch
#4—Pumice (“PFM”), Pumice Filter Material, alumino-silicate), 12×20 mesh, “SLDOX” (CR Minerals Company, LLC, San Juan Pueblo, NM).

### Example 1A: Single Beds with Only 1 Media (SB1-1)

1—CC
2—AG
3—SS
4—PFM
This variation provides 4 separate beds each with a single media type.

Knowing that the specific blend or formulation may depend on the chemistry of the water to be treated, and perhaps other physical characteristics, e.g., temperature, turbidity, varying amounts of each media may be required to provide the best anti-scale and anti-corrosion treatment. Such blends for optimum treatment may be prepared by blending different ratios or percentages of each of the media (as weight or volume) in the Example beds of 1B, 1C and 1D below.

### Example 1B: Single Beds with Blend of 2 Different Media (SB1-2)

1, 2—CC, AG
1, 3—CC, SS
1, 4—CC, PFM
2, 3—AG, SS
2, 4—AG, PFM
3, 4—SS, PFM

This implementation provides 6 different blends (beds), each having various blends with 2 media types. For any one blend of two media where the percentage of any one of the media may be from about 10% up to about 90% of the total volume or weight.

### Example 1C: Single Beds with Blend of 3 Different Media (SB1-3)

1, 2, 3—CC, AG, SS
1, 2, 4—CC, AG, PFM
1, 3, 4—CC, SS, PFM
2, 3, 4—AG, SS, PFM

This variation provides 4 separate blends (beds), each having various blends with 3 media types. For any blend of 3 media where the percentage of any one of the media may be from about 10% up to about 80%, with the percentage of any one of the other 2 media being from about 10% up to about 80% of the total volume or weight.

### Example 1D: Single Bed with Blend of 4 Different Media (SB1-4)

1, 2, 3, 4—CC, AG, SS, PFM

This implementation provides a single beds having various blends with all 4 media types. For any blend of 4 media where the percentage of any one of the media may be from about 10% up to about 70%, with the percentage of any one of the other 3 media being from about 10% up to about 70% of the total volume or weight.

Further, the above-described single beds may be configured as Tandem Beds. Different combinations of the above single beds may be considered for use as a pretreatment for a following (downstream) bed or beds in tandem, many different combinations are possible, including by reversing the position of the described tandem beds relative to up flow through each. The description below provides an illustrative example of how various combinations may provide enhanced scale and corrosion protection over and above any one single bed or certain other tandem bed:

### Example 1E: Tandem Beds Utilizing Single Beds with Only 1 Media (SB1-1+)

Any SB1-1 bed followed by another SB1-1 bed not having the same media; or any of these combinations reversing the position of the tandem beds.

Any SB1-1 bed followed by any SB1-2 bed not containing the same media as the preceding SB1-1 bed; or any of the SB1-1 beds followed by any of the SB1-3 beds not containing the same media as the preceding SB1-1 media; or any of these combinations reversing the position of the tandem beds.

Any SB2-2 beds followed by another SB2-2 bed not having any of the two media in the preceding SB2-2 bed; or any of these combinations reversing the position of the tandem beds.

### Example 2: Evaluation of Blended Anti-Scale/Corrosion Media

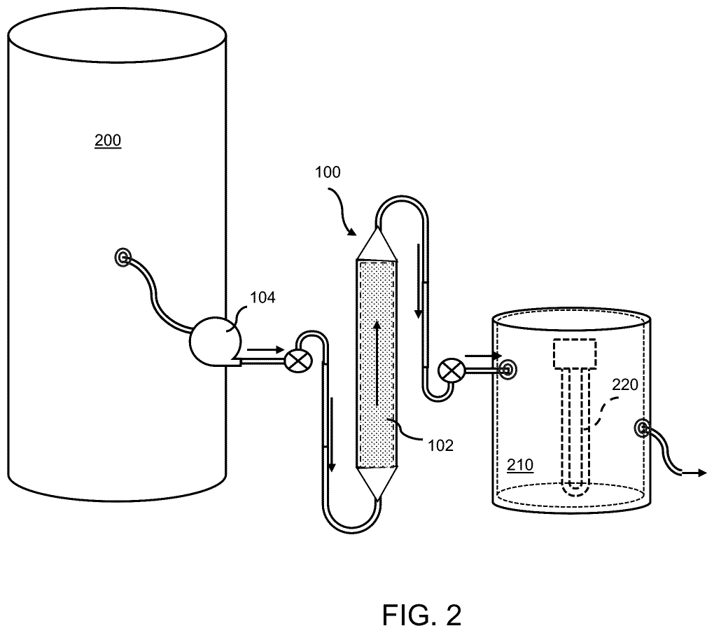

Testing of various blends of anti-scale/corrosion described herein was conducted using multiple test rigs such as the assembly diagrammatically shown in FIG. 2. Four test rigs, each essentially identical to the Standardized Scaling Test Protocol (SSTP) system disclosed by C. Devine et al. (see above reference), were constructed by plumbing four small (6 gallon) electric water heaters 210 in parallel which are fed by a pump 104 from a 250-gallon storage tank 200 containing local Henderson, Nevada municipal water (details provided below). During use, the storage tank 200 was constantly refilled with municipal water using a float switch (not shown) that opened a valve to introduce fresh water. Each water heater 210 utilized identical copper clad heating elements 220 (@ 2,000 W) having approximately 14 sq. in. (90 cm²) of surface area which provides a Watt density of about 142 W/in² (22 W/cm²).

During initial testing (Test Run #1), the test protocol required that each water heater 210 be “on” (heating) for about 8 hrs per day. During the 8-hr heating period, solenoids would “activate” three times allowing about 10 gallons (37.9 L) of flow (@ 1 gpm, 3.8 Lpm) through each water heater per activation period (˜30 gallons (˜114 L) per day, total). Each new tank of water was allowed to heat to the maximum temperature setting (˜145-150° F., 63-66° C.) for about 1.5-2 hours. During a full week of testing, several nights per week, the water heaters were left “on” heating overnight to ensure optimum conditions for scale formation.

### Henderson, NV Test Water Analysis—

Hardness—440 mg/L (as CaCO₃) (˜26 gpg-very hard water)
Total Dissolved Solids, TDS—˜480 mg/L (as sodium chloride, NaCl) (high TDS)
pH—˜7.7-8.0
Temperature—70-75° F. (incoming water)
Alkalinity—˜350 mg/L (as CaCO₃) (high alkalinity)
Silica (as SiO₂)—˜7.6 mg/L

### Test Rig Set-Up—

The water heater 210 in each of the four test rigs was fed untreated municipal water through a separate test pressure vessel (filter housing) 100 containing a canister-type cartridge 102 designed to allow up flow of the incoming water. Test media was placed in each cartridge 102, which was sealed to ensure up flow through the media bed. The pressure vessels 100 were made of clear material (SAN (styrene acrylonitrile)) and the cartridge housing was made of a semi-opaque material such that fluidization of the bed material during flow could be visually observed.

### Example 3: Test Run #1

Test results and observations-A preliminary run was done through four test rigs without any pretreatment to confirm that scale would form on the rods. The rods were then cleaned of the formed scale and testing was re-started to compare pre-treatment cartridges A, B and C in test rigs #1-3, into which were loaded media as follows: Cartridge A: NJ, a Ca-resin as described above (ResinTech, Camden, NJ); Cartridge B: the inventive blended media (CC-AG); and Cartridge C: Filtersorb® SP3 (Watch-Water® GmbH, Mannheim, Germany). This media is described by the manufacturer as “modified ceramic beads” made from a “modified acrylic polymer” coated with calcium hydroxide (Ca(OH)₂ and then surface coated with a “hydrophilic surface” coating of “Glass (SiO₂⁻¹)” (silica) (see Watch-Water® Material Safety Data Sheet with additional information available on the World Wide Web at watchwater.de (“How SP3 Adds Taste to Your Coffee”).)

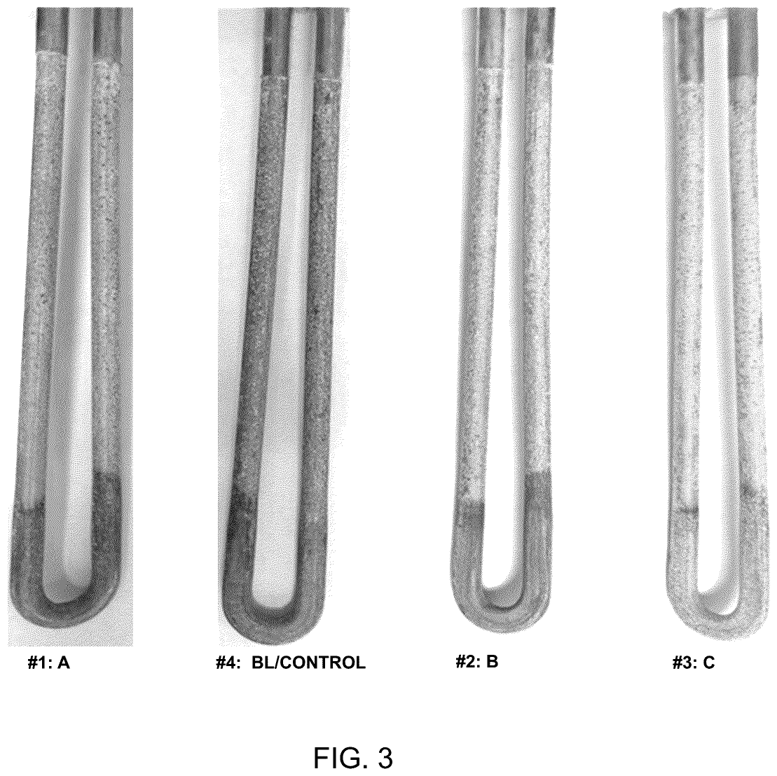

The test rig #4 was set up to run as a base line/control with no filter media. The test rig timers and solenoids were run during the day for three on-off cycles of 10 min on-90 min off at a flow rate through the cartridges of 1.0-1.5 GPM. The water heaters were allowed to remain on (heated) 24 hrs/day. After 100 hours of operation, the rods were removed, photographed (FIG. 3) and visually examined.
1. Cartridge A—(leftmost rod in FIG. 3)—This rod has a very light coating of scale but appears to be similar to the Control rod (shown 2^{nd} from left) with dark/black spots. This observation suggests that the rod is experiencing build-up of scale after which the built-up scale fell off, leaving the rod exposed to corrosion as was the Control rod.
2. Cartridge B—This rod (3^{rd} from left in FIG. 3) exhibits a very slight uniform coating of scale build-up which appears to be less than the scale coating on the Cartridge C (rightmost) rod. We estimate at least 40-50% less scale build-up on the CC-AG treated (Cartridge B) rod compared to the Cartridge C rod. Note that the rod is not as corroded as the Cartridge A and BL/Control rods. Also, when some of the scale was scraped off, it was easily removed (by wiping) and had a soft, powder-like consistency.
3. Cartridge C—This rod (rightmost in FIG. 3) has a moderate uniform coating of white scale. This rod is also not as corroded as the BL/Control and Cartridge A rods. However, when some of the scale on this rod was scraped off, it was difficult to remove and was a hard crystalline scale.
4. Base Line/Control (City water not pretreated)—As seen in the 2^{nd} panel of FIG. 3, the BL rod has barely visible scale build-up as compared to the other rods that were exposed to water pretreated with anti-scale media. However, the rod (copper coated) appears to be corroding as indicated by the dark/black spots. Scale from very hard water is known to form on heater rods in large amounts then fall off. (See C. Devine, et al., Virginia Tech study mentioned supra.) We are confident this is happening to the BL/control rod. When this happens repeatedly, the bare rod is more subject to corrosion as evidenced by the dark/black spots.

### Example 4: Test Run #2

The second test run utilized two test rigs for a comparison of one of the inventive media blends against a commercially-available anti-scale product, Watts/NEXT, available from Next Filtration Technologies, Inc., Boynton Beach, FL.
1. Cartridge D—This variation of the inventive media blend includes 150 mL of calcium carbonate (CC) granules (30×50 mesh, 0.3-0.6 mm) in a homogeneous mix with: 100 mL of the activated glass (AG) media (0.7-2.0 mm); 100 mL of sodium hexameta-phosphate (SHMP, ˜20×80 mesh); and 100 grams of sodium silicate, lumps (10-30 mm, ˜⅜ inch×1.25 inch average size).
2. Cartridge E—Contains 150 mL of Watts/NEXT media. This media is commercially available and is believed to be a calcium-form weak acid cation (WAC) resin as described above, “Ca-resin”.

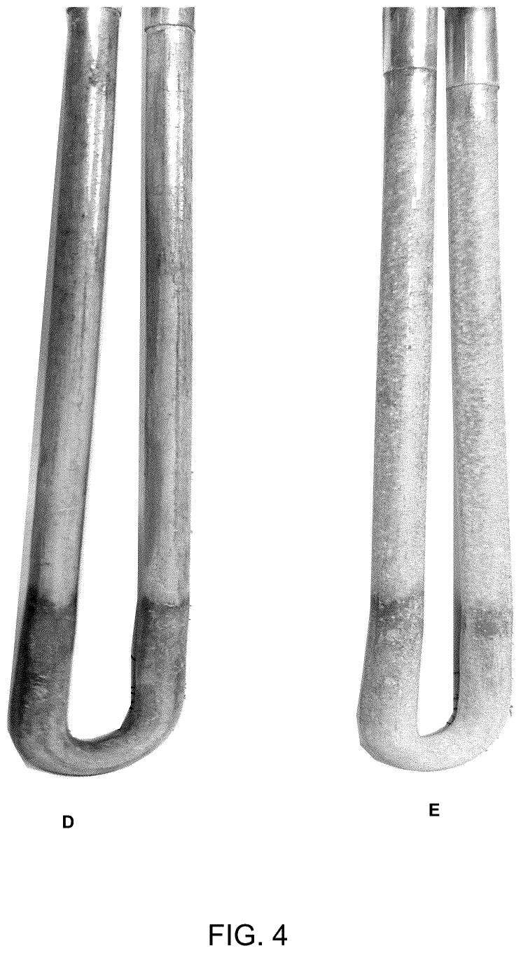

FIG. 4 provides photographs of the heater rods following processing using Cartridges D and E. Procedures and observations in this test run include:

At start-up, two new heating elements (both identical, copper coated) were installed in two of the water heater tanks. After 120 hours of operation, the rods were removed, photographed and visually examined.
Cartridge D rod (left in FIG. 4)—The heating rod from the water heater used with water pre-treated with the inventive media blend is virtually free from any scale build up.
Cartridge E rod (right in FIG. 4)—This rod exhibits a slight uniform coating of scale build-up.

### Example 5: Additional Tests

Additional tests with another slightly modified blend of anti-scale media (labeled CP77—approx. 200 mL total volume) were conducted on the test rig as described above. This cartridge contains a variation of the inventive blended media with: 50-100 mL of calcium carbonate granules, 30×50 mesh; 50-100 mL of activated glass (AG), 0.7-2.0 mm; and 50-70 grams (˜50 mL) of a mixed size of granular sodium silicate glass (SS22, PQ Corporation), approximately >20 mesh with 0.25 inch×1.5 inch average size. Adjustments in the ratios and mixture may be made based on characteristics of the incoming water, including alkalinity, hardness, pH, etc. as well as environmental conditions including temperature.

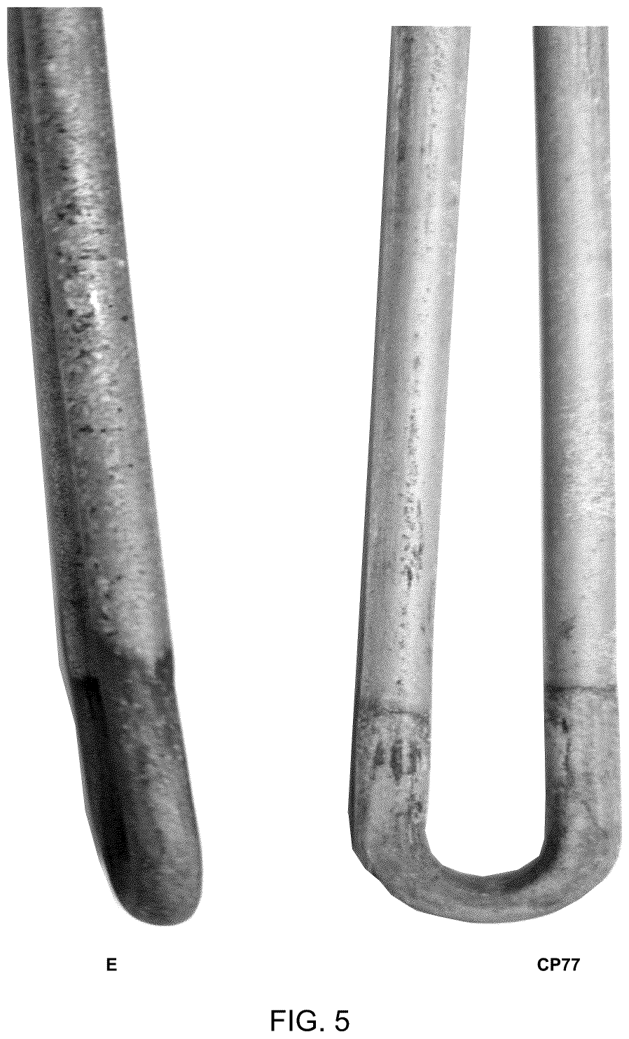

This cartridge with the modified blend (CP77) was tested head-to-head against a cartridge containing 150 mL the Watts/NEXT media (Cartridge E in the previous test). The photo in FIG. 5 shows a significant difference in the condition of the heater rods after 200 hrs of testing with the Cartridge E media (left panel) versus 200 hrs of testing with the CP77 media (right panel).

### SUMMARY

Test results reveal that the blends of the inventive media blends as utilized in a fluidized bed contacter outperform the commercially available Filtersorb® SP3 (Cartridge C) anti-scale media, the NJ Ca-resin media (Cartridge A), and the Watts/NEXT media (Cartridge E). As shown in FIG. 3, the inventive media in Cartridge B allowed about 40-50% less scale to form on its heater rod compared to the scale on the Cartridge C rod. Further, the scale that did form on the Cartridge B rod was easily removed and was in a soft powder form rather than the hard crystalline form on the Cartridge C rod. Very slow slight scale formation on heater rods could actually provide an advantage by protecting the rod from corrosion while still allowing the rod to effectively heat the water. Note also in FIG. 3 that the Cartridge A rod, though with about the same amount of scale on the rod as the Cartridge B rod, shows apparent corrosion (black spots and pitting). This may indicate scale forming on the NJ rod, then falling off leaving the rod exposed to corrosion. FIG. 4 clearly shows that the Cartridge D in Run #2 outperformed the Cartridge E media.

The extreme corrosion evidenced by black spots and deep pits in the rods may be a result of carbonic acid (H₂CO₃) released as a result of the anti-scale mechanism by these Ca-resins (Cartridge A and Cartridge E resins) (see “Can Physical Water Treatment Prevent and Control Scale?”, K. Smith, Water Conditioning & Purification, February 2007). The proposed anti-scale mechanism by the activated glass (AG) used in the inventive blends may also release carbonic acid in the same way, however, when AG is blended with granules of calcium carbonate (CaCO₃) and sodium silicate glass, both of these compounds have the ability to neutralize H₂CO₃. Note in the above chemical reactions describing the dissolution of the alkaline silicates that hydroxyl ion (OH⁻¹) is released. These interactions explain why the rods exposed to the Cartridge B, D and CP77 inventive media prevent corrosion of the heating rods.

The results from the additional tests of the CP77 media versus the Cartridge E media (FIGS. 4-5) clearly show that the CP77 media outperforms the Cartridge E media for preventing scale formation on the heating rods and, importantly, extending the life of the heating rod by preventing corrosion.

Unlike many resin-based media currently in use, the inventive approach is not susceptible to higher concentrations of chlorine and chloramine, nor is it easily fouled by organics, iron, copper, manganese, or other metals. The compact nature of the contained fluidized beds allows the inventive scheme to be easily adapted to limited space applications.

While the foregoing descriptions and accompanying drawings set forth functional aspects of the disclosed system, no particular arrangement of elements for implementing these functional aspects should be inferred from the illustrative examples unless explicitly stated or otherwise clear from the context. All such variations and modifications are intended to fall within the scope of this disclosure.

1. A system for controlling scale formation and corrosion in a water system, comprising:
a contained fluidized bed (CFB) configured to retain components of a blended media, the components comprising:
(a) calcium carbonate granules;
(b) activated glass granules;
(c) pumice; and
(d) one or a combination of silicates selected from alkaline earth metal silicates (AEM) and alkaline metal (AM) silicates, wherein the one or a combination of silicates is configured for variable solubility by releasing a first level of silica for passivation and at least one second level of silica lower than the first level for maintenance of passivation, wherein the CFB is configured for receiving an input water flow and outputting an output water flow.

2. The system of claim 1, wherein the AEM is one or more of magnesium, calcium and barium, and the AM is sodium and potassium.

3. The system of claim 1, wherein component (b) is configured for creating suspended micron- and sub-micron CaCO₃ crystals for seeding Ca⁺² ions from hard water and forming microcrystalline CaCO₃ that remains in solution.

4. The system of claim 1, wherein component (a) is configured for creating suspended micron- and sub-micron CaCO₃ crystals for seeding Ca⁺² ions from hard water and forming microcrystalline CaCO₃ that remains in solution.

5. The system of claim 1, wherein the CFB comprises multiple beds in fluid communication, wherein each bed is configured to retain from one to three of components (a)-(d).

6. The system of claim 1, wherein the CFB comprises multiple beds in fluid communication, where at least a first bed of the multiple beds retains component (a).

7. The system of claim 1, wherein the CFB comprises multiple beds, each bed comprising a vertically-oriented column disposed within an array of parallel columns.

8. The system of claim 1, wherein the CFB comprises multiple beds, each bed comprising a vertically-oriented column disposed within a series of columns.

9. The system of claim 1, wherein component (c) comprises aluminosilicates.

10. The system of claim 1, wherein the components further comprise sodium hexameta phosphate (SHMP).

11. A method for controlling scale formation and corrosion in a water system, comprising pumping water into the system of claim 1.

12. A blended media composition for use in a contained fluidized bed (CFB), the composition comprising:
(a) calcium carbonate granules;
(b) activated glass granules;
(c) pumice; and
(d) one or a combination of silicates selected from alkaline earth metal silicates (AEM) and alkaline metal (AM) silicates, wherein the silicates are configured for variable solubility by releasing a first level of silica for passivation and at least one second level of silica lower than the first level for maintenance of passivation.

13. The composition of claim 12, wherein the AEM is one or more of magnesium, calcium and barium, and the AM is sodium and potassium.

14. The composition of claim 12, wherein (b) is configured for creating suspended micron- and sub-micron CaCO₃ crystals for seeding Ca⁺² ions from hard water and forming microcrystalline CaCO₃ that remains in solution.

15. The composition of claim 12, wherein (a) is configured for creating suspended micron- and sub-micron CaCO₃ crystals for seeding Ca⁺² ions from hard water and forming microcrystalline CaCO₃ that remains in solution.

16. The composition of claim 12, wherein the CFB comprises multiple beds in fluid communication, wherein each bed is configured to retain from one to three of (a)-(d).

17. The composition of claim 12, wherein the CFB comprises multiple beds in fluid communication, where at least a first bed of the multiple beds retains (a).

18. The composition of claim 12, wherein (c) comprises aluminosilicates.

19. The composition of claim 12, further comprising sodium hexameta phosphate (SHMP).
